(19) United States
(12) Patent Application Publication
(10) Pub. No.: US 2021/0378267 A1
(43) Pub. Date: Dec. 9, 2021

(54) A SET-UP FOR PREPARING ENHANCED BEVERAGES

(71) Applicant: Roi BARAK, Yehiam (IL)

(72) Inventor: Roi BARAK, Yehiam (IL)

(21) Appl. No.: 17/288,301

(22) PCT Filed: Oct. 23, 2019
(86) PCT No.: PCT/IL2019/051145

§ 371 Date: Apr. 23, 2021

Related U.S. Application Data
(60) Provisional application No. 62/749,285, filed on Oct. 23, 2018.

(51) Int. Cl. A23L 2/56; A23L 2/40; B65D 85/804; B65D 85/808; A23L 2/395; A47J 31/40; A23P 10/30

(52) U.S. Cl. CPC A23L 2/56; A23L 2/40; B65D 85/8043; A23V 2002/00; A23L 2/395; A47J 31/407; A23P 10/30; B65D 85/808

(57) ABSTRACT

A set-up to be implemented in a water/beverage system for adding flavors, minerals, and/or nutritional supplements to beverages. The set-up comprises a sealed capsule containing said flavors, minerals and/or nutritional supplements. The capsule comprises a container with an upper wall and a bottom wall that are either tearable and/or dissolvable when subjected to a stream of fluid and/or to a pressure/force exerted thereon, and a housing for securely holding the capsule in the water/beverage system.

### FIELD OF THE INVENTION

The present invention relates to drinking water enhancement. More particularly, the present invention relates to enhancing beverages via flavors, minerals and/or nutritional supplements.

### BACKGROUND OF THE INVENTION

Water is essential for life. However, most people do not consume the recommended 6-8 cups of water per day since plain water is considered ‘boring’ to many people. To make drinking water more enjoyable, consumers may add additives, such as liquid or powdered flavoring. In addition, consumers may add minerals and/or nutritional supplements to their drinking water to increase their nutritional value. However, liquid and powdered flavorings tend to be messy and/or awkward to dispense and to use. Thus, an aim of the present invention is to provide a tidy and convenient set-up for adding flavors, minerals and/or nutritional supplements to beverages.

### SUMMARY OF THE INVENTION

In accordance with some embodiments of the present invention, there is thus provided a set-up to be implemented in a water/beverage system for adding flavors, minerals, and/or nutritional supplements to beverages. The set-up comprises:
a sealed capsule containing said flavors, minerals and/or nutritional supplements, said capsule comprises a container with an upper wall and a bottom wall that are either tearable and/or dissolvable when subjected to a stream of fluid and/or to a pressure/force exerted thereon, and
a housing for securely holding said capsule in said water/beverage system.

Furthermore, in accordance with some embodiments of the present invention, water/beverage system is selected from water purification and filtration systems and systems for making carbonated/non-carbonated beverages.

Furthermore, in accordance with some embodiments of the present invention, the housing is a funnel-type housing.

Furthermore, in accordance with some embodiments of the present invention, the container is a cup-shaped container.

Furthermore, in accordance with some embodiments of the present invention, the cup-shaped container is a self-supporting cup-shaped container with planar bottom and upper walls, and a side wall, part of said side wall gradually truncates towards said planar bottom wall.

Furthermore, in accordance with some embodiments of the present invention, the side wall is made of a stiff material selected from a metal, a metal alloy, polymer(s), a polymer-metal/metal alloy composite material or a combination thereof.

Furthermore, in accordance with some embodiments of the present invention, the planar bottom wall and/or said planar upper wall is made of soft/semi soft material selected from a soft metal/alloy, polymer(s) or a combination thereof.

Furthermore, in accordance with some embodiments of the present invention, the capsule is either a soluble or a non-soluble capsule.

Furthermore, in accordance with some embodiments of the present invention, the soluble capsule is made of material(s) or chemical(s) that react with water, said material(s) or chemical(s) are selected from gelatin, starch, sugar, fibrous or cellular materials, sodium, calcium or a polymer.

Furthermore, in accordance with some embodiments of the present invention, the polymer is a PVOH-Polyvinyl alcohol.

Furthermore, in accordance with some embodiments of the present invention, the housing is a funnel-type housing made of a metal, a metal alloy, polymer(s), a polymer-metal/metal alloy composite material or a combination thereof.

Furthermore, in accordance with some embodiments of the present invention, the funnel-type housing holds the capsule in place and conveys the content of the capsule into a water/sparkling water medium in said water/beverage systems.

Furthermore, in accordance with some embodiments of the present invention, the capsule is implemented in a drinking water faucet to produce a carbonated/non-carbonated beverage, said faucet comprises a body into which said capsule is insertable, wherein water/carbonated water flows within said body of said faucet upwards/downwards towards a faucet tip, passes by and dissolves said capsule, and mixes with the capsule's content, a mixture of said water/carbonated water and said capsule's content continues flowing towards said faucet tip.

Furthermore, in accordance with some embodiments of the present invention, there is provided a method for using the above-described setup in a water/beverage system for adding flavors, minerals, and/or nutritional supplements to beverages. The method comprises:

positioning said set-up in said water/beverage system, said set-up comprises a capsule and a funnel-type housing; and
subjecting an upper wall of said capsule to a stream of fluid and/or to a pressure/force to tear/dissolve said upper wall and to tear/dissolve a bottom wall of said capsule.

Furthermore, in accordance with some embodiments of the present invention, the water/beverage system is selected from water purification and filtration systems, sparkling water makers, and industrial and semi-industrial machines.

Furthermore, in accordance with some embodiments of the present invention, the stream of fluid is a gaseous stream having a pressure of at least 40 Bar.

Furthermore, in accordance with some embodiments of the present invention, the sparkling water maker is a soda siphon carbonated water and said method further comprising:
subjecting a gaseous stream to an upper wall of said capsule,
tearing said upper wall and a bottom wall of said capsule via said gaseous stream,
flowing said gaseous stream through said funnel-type housing into a water medium, and
flowing sparkling water mixed with said capsule content upwards through said funnel-type housing and through said capsule.

Furthermore, in accordance with some embodiments of the present invention, the sparkling water system is a Soda Stream jet sparkling water maker, and said method further comprising:
subjecting a gaseous stream to an upper wall of said capsule,
tearing said upper wall and a bottom wall of said capsule via said gaseous stream, and
flowing said gaseous stream through said funnel-type housing into a water medium.

Furthermore, in accordance with some embodiments of the present invention, the method further comprising:
subjecting a water stream to an upper wall of said capsule,
dissolving said upper wall and a bottom wall of said capsule via said water stream, and
flowing said water stream through said funnel-type housing into a water medium.

Furthermore, in accordance with some embodiments of the present invention, the method further comprising:
subjecting said upper wall of said capsule to force;
tearing said upper wall via said force,
directing a water stream into the capsule,
dissolving a bottom wall of said capsule via said water stream, and
flowing said capsule's content through said funnel-type housing into a water medium.

Furthermore, in accordance with some embodiments of the present invention, the method further comprising:
subjecting said upper wall of said capsule to force;
tearing said upper wall via said force,
directing a water stream into the capsule,
dissolving a bottom wall of said capsule via said water stream, and
flowing said capsule's content through said funnel-type housing into a water medium.

Furthermore, in accordance with some embodiments of the present invention, the method further comprising:
subjecting said upper wall of said capsule to force;
tearing said upper wall via said force,
directing a gaseous stream into the capsule,
tearing a bottom wall of said capsule via said gaseous stream, and
flowing said capsule's content through said funnel-type housing into a water medium.

Furthermore, in accordance with some embodiments of the present invention, the method further comprising:
subjecting said upper wall of said capsule to force;
tearing said upper wall via said force,
directing a water stream into the capsule,
tearing a bottom wall of said capsule via said water stream, and
flowing said capsule's content through said funnel-type housing into a water medium

Furthermore, in accordance with some embodiments of the present invention, the method further comprising:
subjecting said upper wall of said capsule to force;
tearing said upper wall via said force,
directing a gaseous stream into the capsule,
tearing and/or dissolving a bottom wall of said capsule via said gaseous stream,
flowing said capsule's content through said funnel-type housing into a water medium, and
flowing sparkling water mixed with said capsule content upwards through said funnel-type housing and through said capsule.

Furthermore, in accordance with some embodiments of the present invention, the method further comprising dissolving said capsule.

### BRIEF DESCRIPTION OF THE FIGURES

FIG. 1 is a plan view of a set-up for adding flavors, minerals and/or nutritional supplements to carbonated/noncarbonated beverages according to some embodiments of the present invention.

FIGS. 2A-C illustrate a set of 3 stages taking place in a soda siphon carbonated water maker while being operated in accordance with some embodiments of the present invention.

FIGS. 3A-D illustrate a set of 4 stages taking place in a soda siphon carbonated water maker while being operated in accordance with some embodiments of the present invention.

FIGS. 4A&B illustrate a set of 2 stages taking place in a Soda Stream jet sparkling water maker while being operated in accordance with some embodiments of the present invention.

FIGS. 5A-C illustrate a set of 3 stages taking place in water purification and filtration systems for home use such as, for instance, the Tami 4 type water purifier and industrial and semi-industrial machines for the preparation of carbonated and non-carbonated beverages in accordance with some embodiments of the present invention.

FIGS. 6A-C illustrate a set of 3 stages taking place in water purification and filtration systems, sparkling water makers, such as, for instance, Tami4, and industrial and semi-industrial machines for the preparation of carbonated and non-carbonated beverages in accordance with some embodiments of the present invention.

FIGS. 7A-C illustrate a set of 3 stages taking place in sparkling water makers such as, for instance, a soda siphon carbonated water maker and a Soda Stream jet sparkling water maker in accordance with some embodiments of the present invention.

FIGS. 8A-D illustrate a set of 4 stages taking place in a water purification and filtration system for home use such as, for instance, the Tami 4 type water purifier and industrial and semi-industrial machines for the preparation of carbonated and non-carbonated beverages in accordance with some embodiments of the present invention.

FIGS. 9A-D illustrate a set of 4 stages taking place in a soda siphon carbonated water maker in accordance with some embodiments of the present invention.

FIG. 10 illustrates a capsule implemented in a drinking water faucet for the preparation of carbonated and for non-carbonated beverages in accordance with some embodiments of the present invention.

FIG. 11 illustrates a soda siphon carbonated water maker with a capsule secured in a funnel-type housing for producing beverages.

### DETAILED DESCRIPTION OF THE FIGURES

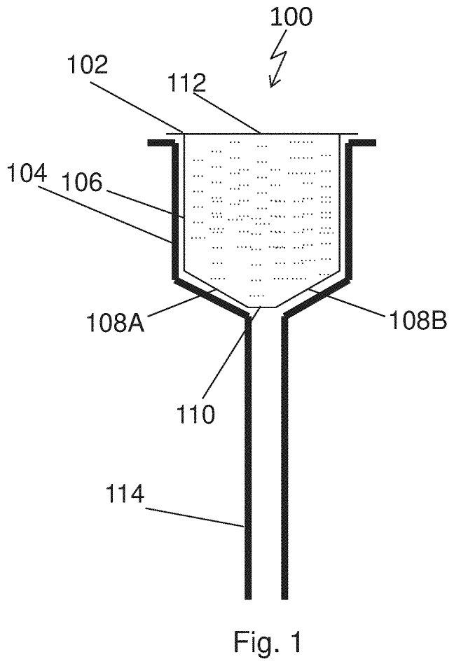

FIG. 1 is a plan view of a set-up 100 for adding flavors, minerals and/or nutritional supplements to beverages according to some embodiments of the present invention.

As seen in the figure, set-up 100 comprises a sealed capsule 102 and a compatible housing—a funnel-type housing 104.

Capsule 102 comprises a self-supporting cup-shaped container with planar bottom wall 110, planar upper wall 112, and a side wall 106 part of which is truncating towards planar bottom wall 110.

Side walls 106A&B may be made of a relatively stiff material such as, for instance, a metal, a metal alloy, a polymer, a polymer-metal alloy composite material or a combination thereof to not collapse while in use. In contrast, planar bottom wall 110 and planar upper wall 112 may be made of a relatively soft/semi soft material such as, for instance, a soft metal/alloy, a polymer or a combination thereof to be easily torn when subjected to pressure of gas molecules or to force exerted thereon.

In accordance with some embodiments, it is possible that capsule 102 may be soluble and thus may be made of a water-soluble, absorbent or disintegrable substance such as gelatin, starch, sugar; fibrous or cellular materials or chemicals that react with water, such as sodium (Na) or calcium (Ca), a polymeric material such as PVOH-Polyvinyl alcohol of MonoSol all of which being readily softened or disintegrate when soaked or even wetted by liquid.

In accordance with some embodiments of the present invention, funnel-type housing 104 may be made of a metal, a metal alloy, a polymer, a polymer-metal alloy composite material or a combination thereof.

The role of funnel-type housing 104 is two-fold: (a) to hold capsule 102 in place while in operation, i.e., while force/pressure is applied onto capsule 102, as seen in FIG. 1, capsule 102 is securely inserted into funnel-type housing 104 and fitted therein, and (b) to convey the content of capsule 102 into the water/sparkling water medium.

In accordance with some embodiments of the present invention, set-up 100 may be suitable for use in various water purification and filtration systems, in various sparkling water makers, such as, for instance, a Soda Stream device, and in industrial and semi-industrial machinery as seen and described in the following figures.

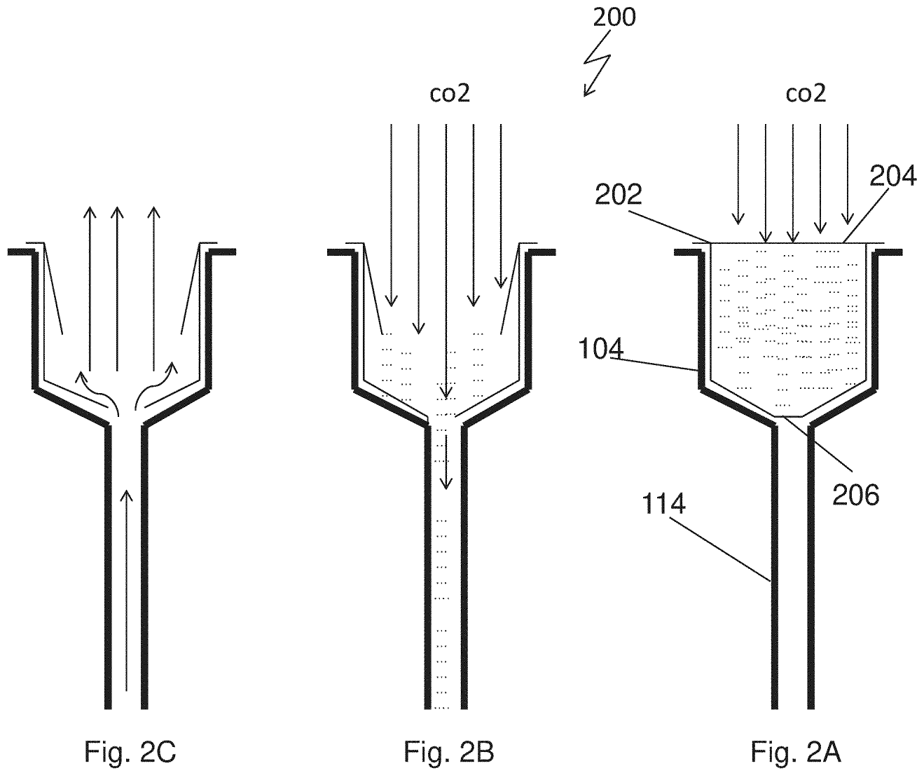

FIGS. 2A-C illustrate a set of 3 stages 200 taking place in a soda siphon carbonated water maker while being operated in accordance with some embodiments of the present invention. Seen in the figures is the set-up 100 of FIG. 1 with a non-soluble capsule 202 which is implemented in the soda siphon carbonated water maker.

As seen in FIG. 2A, non-soluble capsule 202 is secured in funnel-type housing 104 while a gaseous stream is subjected to the upper planar wall 204 of capsule 202.

In accordance with some embodiments of the present invention, the gas pressure may be relatively high and may attain at least 40 bar.

In FIG. 2B the gas stream tears both planar upper wall 204 and planar bottom wall 206 and flows through funnel 114 into the water medium.

FIG. 2C shows the flow direction of the water that is mixed with the content of capsule 202 and with gas molecules. Due to the gas molecules, the sparkling water flow upwards through funnel 114 and through capsule 202.

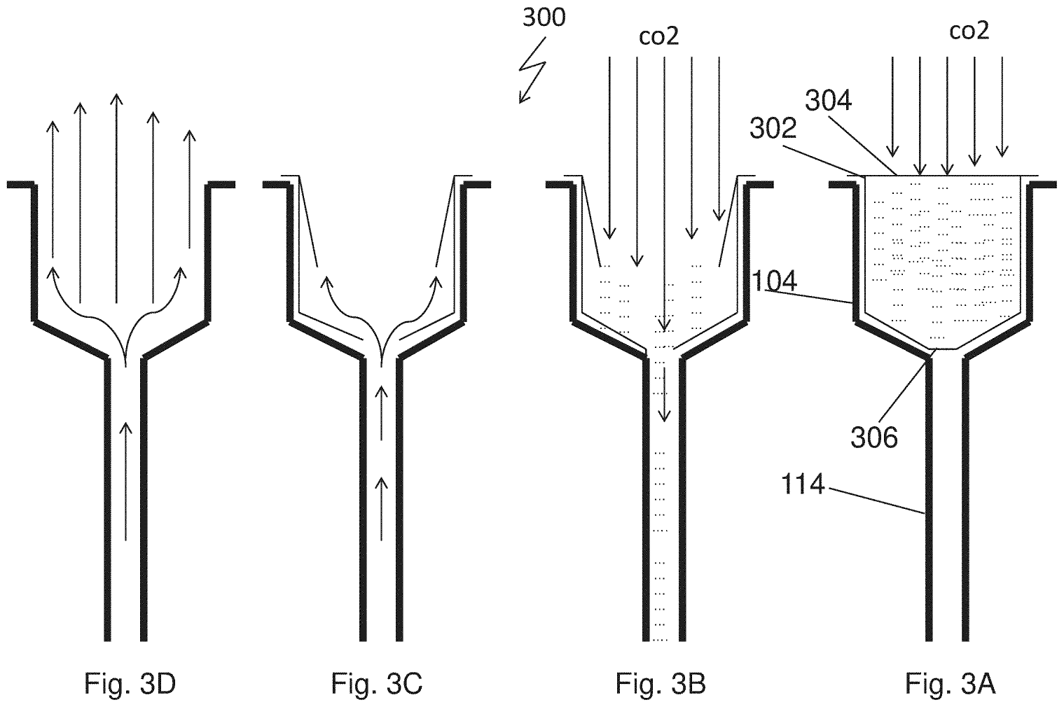

FIGS. 3A-D illustrate a set of 4 stages 300 taking place in a soda siphon carbonated water maker while being operated in accordance with some embodiments of the present invention. Seen in the figures is the set-up 100 of FIG. 1 with a soluble capsule 302 which is implemented in the soda siphon carbonated water maker.

As seen in FIG. 3A, soluble capsule 302 is secured in funnel-type housing 104, and a gaseous stream is subjected to the upper planar upper wall 304 of capsule 302.

In accordance with some embodiments of the present invention, the gas pressure may be relatively high and may attain at least 40 bar.

In FIG. 3B the gas stream tears both planar upper wall 304 and planar bottom wall 306 and flows through funnel 114 into the water medium.

FIG. 3C shows the flow direction of the water that is mixed with the content of capsule 302 and with gas. Due to the gas molecules, the sparkling water flows upwards through funnel 114 and through capsule 302. At this stage capsule 302 has not dissolved yet and thus as seen in the figure, has its original structure.

FIG. 3D illustrates an advanced stage in which the flow increases and capsule 302 is completely dissolved.

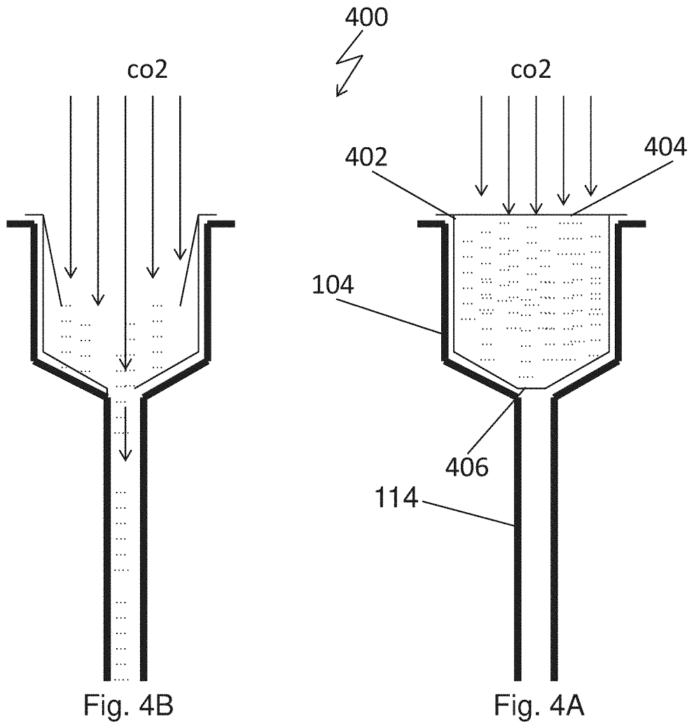

FIGS. 4A&B illustrate a set of 2 stages 400 taking place in a Soda Stream jet sparkling water maker while being operated in accordance with some embodiments of the present invention. Seen in the figures is the set-up 100 of FIG. 1 with a non-soluble capsule 402 which is implemented in the Soda Stream jet sparkling water maker.

As seen in FIG. 4A, non-soluble capsule 402 is secured in funnel-type housing 104, and a gaseous stream is subjected onto the planar upper wall 404 of capsule 402.

In accordance with some embodiments of the present invention, the gas pressure may be relatively high and may attain at least 40 bar.

In FIG. 4B the gas stream tears both planar upper wall 404 and planar bottom wall 406 and flows through funnel 114 into the water medium.

In contrast to the soda siphon carbonated water maker illustrated in FIGS. 2A-C and 3A-D, in the Soda Stream jet sparkling water maker shown in here, the water mixed with the capsule content and with gas molecules does not flow upwards but rather through funnel 114 into the water medium.

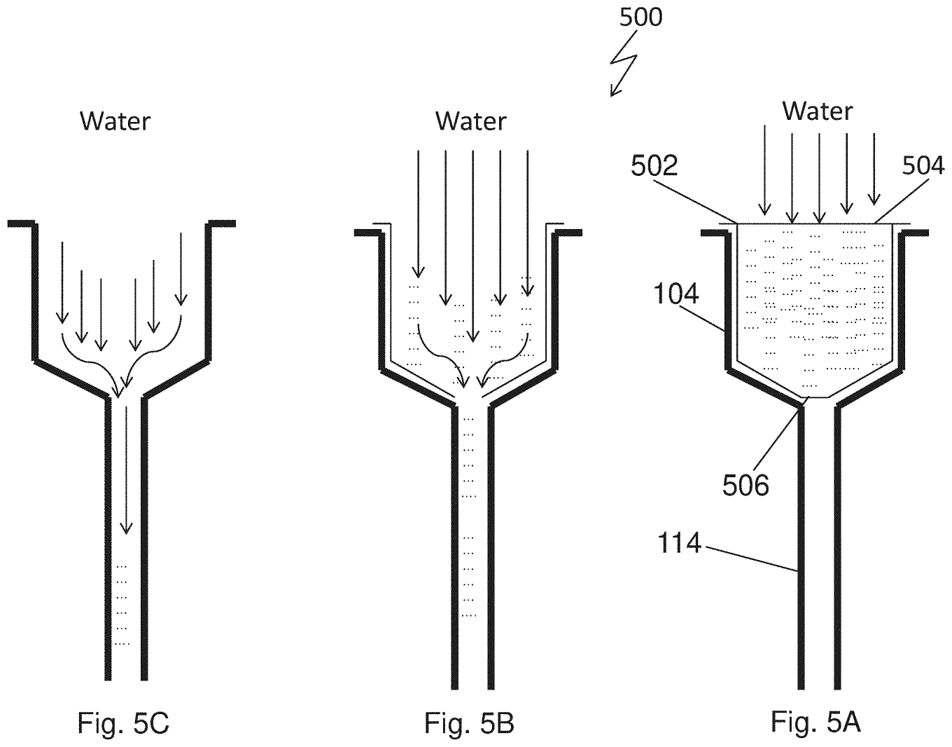

FIGS. 5A-C illustrate a set of 3 stages 500 taking place in a water purification and filtration system for home use such as, for instance, the Tami 4 type water purifier and industrial and semi-industrial machines for the preparation of carbonated and non-carbonated beverages in accordance with some embodiments of the present invention. Seen in the figures is the set-up 100 of FIG. 1 with a soluble capsule 502.

As seen in FIG. 5A, soluble capsule 502 is secured in funnel-type housing 104, and a water stream is subjected onto the upper planar upper wall 504 of capsule 502.

In FIG. 5B the water stream dissolves both planar upper wall 504 and planar bottom wall 506 and flows through funnel 114 into the water medium.

FIG. 5C illustrates an advanced stage in which the flow increases and capsule 502 completely dissolved.

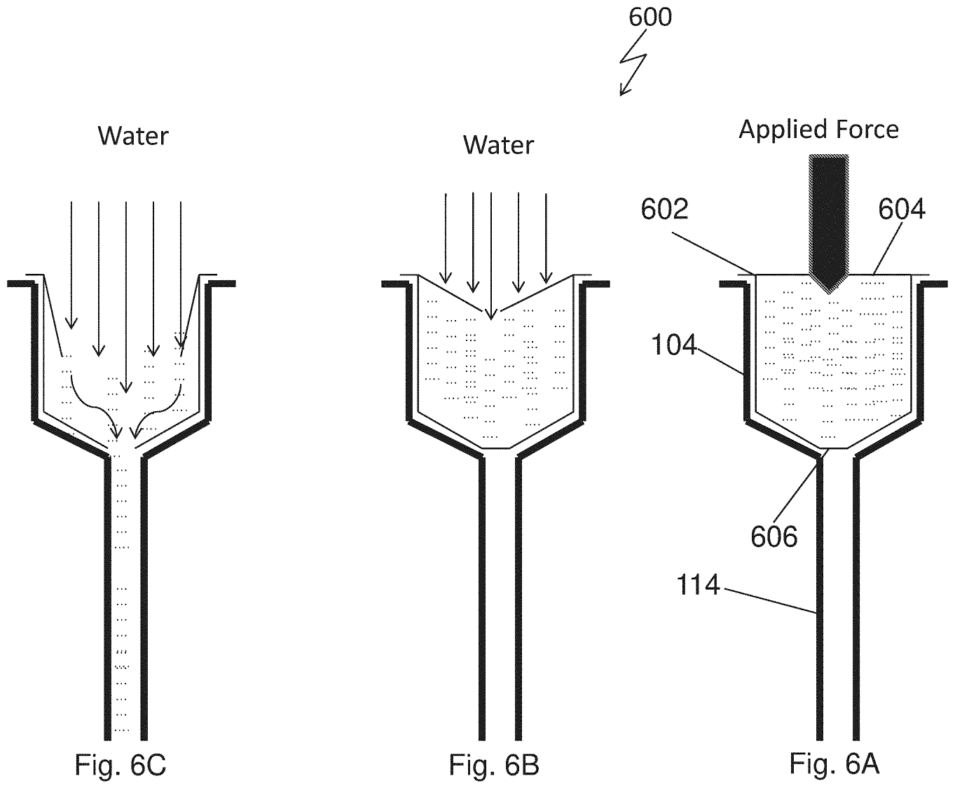

FIGS. 6A-C illustrate a set of 3 stages 600 taking place in a water purification and filtration system and/or a sparkling water maker, such as, for instance, Tami 4, and industrial and semi-industrial machines for the preparation of carbonated and non-carbonated beverages in accordance with some embodiments of the present invention. The system is equipped with a non-soluble capsule 602 where planar upper wall 604 and planar bottom wall 606 of non-soluble capsule 602 are subjected to force such as a mechanical force.

As seen in FIG. 6A, non-soluble capsule 602 is secured in funnel-type housing 104 where the planar upper wall 604 is subjected to force.

Seen in FIG. 6B, planar upper wall 604 tears as a result of the applied force, and a water stream is directed into the capsule 602.

As seen in FIG. 6C, planar bottom wall 606 dissolves in water, and the content of capsule 602 flows through funnel 114 into the water medium.

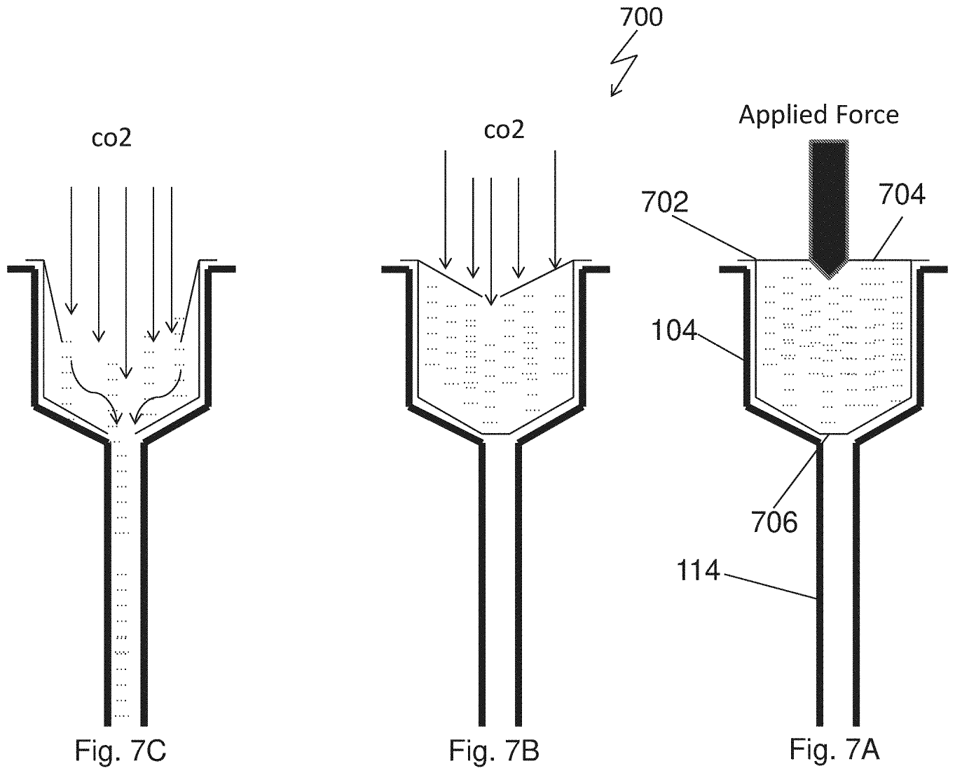

FIGS. 7A-C illustrate a set of 3 stages 700 taking place in a sparkling water maker such as, for instance, a soda siphon carbonated water maker and a Soda Stream jet sparkling water maker, while being operated in accordance with some embodiments of the present invention.

Seen in the figures is the set-up 100 of FIG. 1 with a non-soluble capsule 702 implemented in the sparkling water maker.

In FIG. 7A, non-soluble capsule 702 is secured in funnel-type housing 104, and upper planar upper wall 704 of capsule 702 is subjected to force.

Seen in FIG. 7B, planar upper wall 704 tears as a result of the applied force, and a gas stream is directed into the capsule 702.

As seen in FIG. 7C, the planar bottom wall 706 tears as a result of the pressure applied by the flowing gas, and the content of capsule 702 flows through funnel 114 into the water medium.

In accordance with some embodiments of the present invention, the gas pressure may be relatively high and may be at least 40 bar.

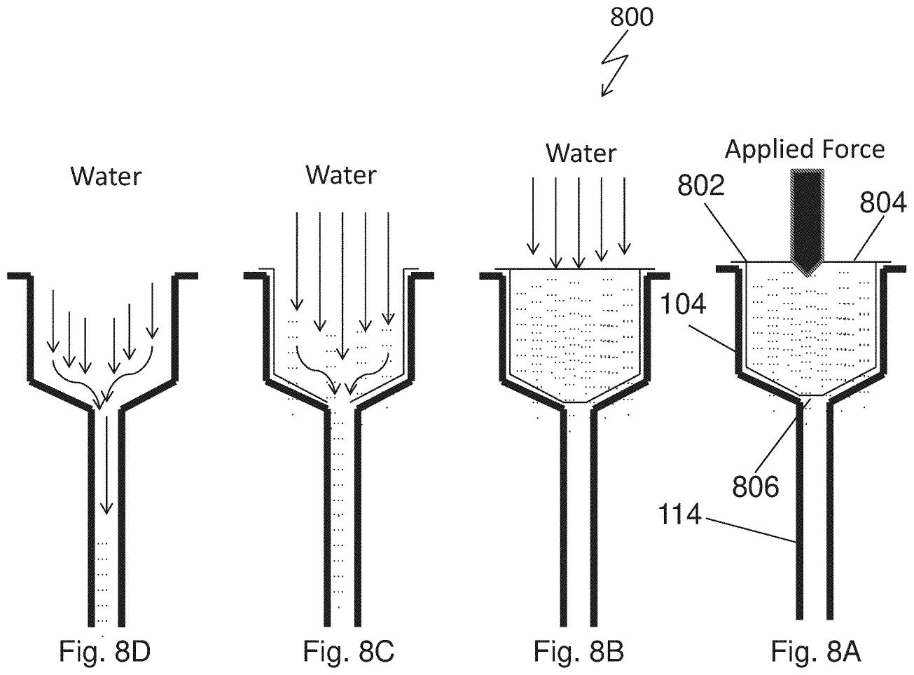

FIGS. 8A-D illustrate a set of 4 stages 800 taking place in a water purification and filtration system for home use such as, for instance, the Tami 4 type water purifier and industrial and semi-industrial machines for the preparation of carbonated and non-carbonated beverages in accordance with some embodiments of the present invention. Seen in the figures is the set-up 100 of FIG. 1 with a soluble capsule 802 implemented in the sparkling water maker.

In FIG. 8A, soluble capsule 802 is secured in funnel-type housing 104, and upper planar upper wall 804 of capsule 802 is subjected to force.

Seen in FIG. 8B, planar upper wall 804 tears as a result of the applied force, and a water stream is directed into the capsule 802.

As seen in FIG. 8C, the planar bottom wall 806 tears/dissolves by the water stream, and the content of the capsule 802 flows through funnel 114 into the water medium.

In FIG. 8D, the capsule 802 is completely dissolved and its content keeps flowing into the water medium.

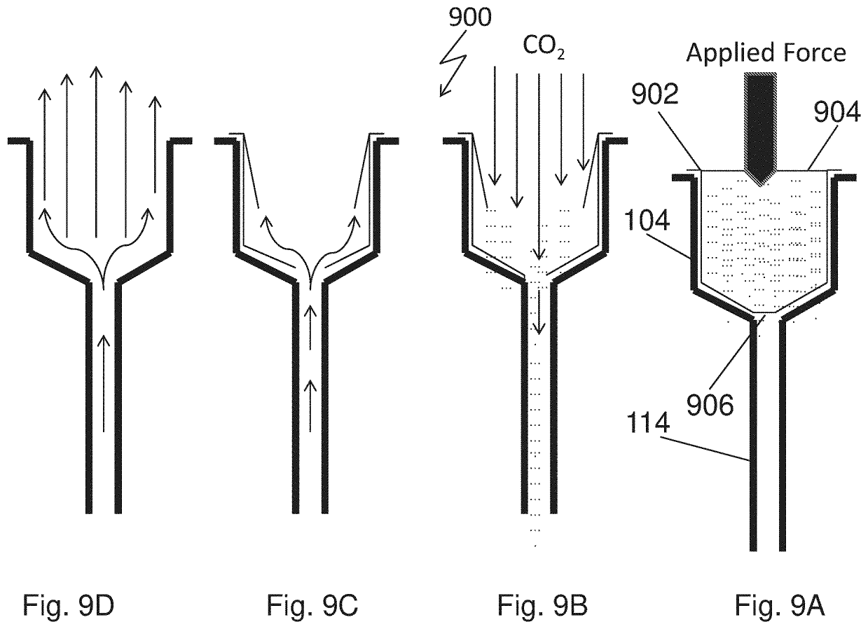

FIGS. 9A-D illustrate a set of 4 stages 900 taking place in a soda siphon carbonated water maker in accordance with some embodiments of the present invention. Seen in the figures is the set-up 100 of FIG. 1 with a soluble capsule 902 which is implemented in the soda siphon carbonated water maker.

As seen in FIG. 9A, soluble capsule 902 is secured in funnel-type housing 104, and its upper planar wall 904 is subjected to force.

The upper planar wall 904 tears as a result of the applied force and gas is directed into the capsule 902, tears/dissolves the bottom planar wall 906 and flows through funnel 114 as seen in FIG. 9B.

In accordance with some embodiments of the present invention, the gas pressure may be relatively high and may attain at least 40 bar.

FIG. 9C shows the flow direction of the gas mixed with the content of capsule 902 and with water. Due to the gas molecules, the sparkling water flows upwards through funnel 114 and through capsule 902. At this stage capsule 902 has not dissolved yet and thus as seen in the figure, has its original structure.

FIG. 9D illustrates an advanced stage in which the flow upwards increases and capsule 902 is completely dissolved.

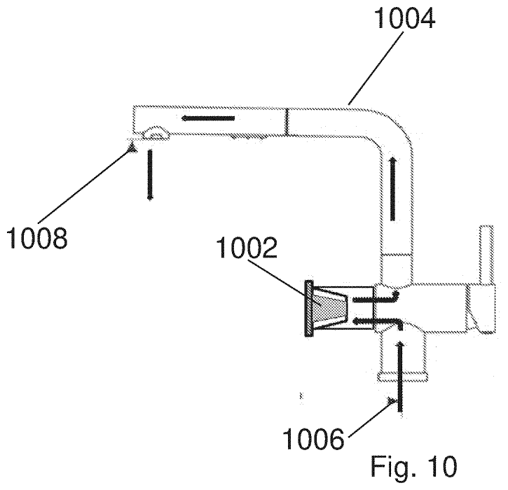

FIG. 10 illustrates a capsule 1002 implemented in a drinking water faucet 1004 for the preparation of carbonated and/or non-carbonated beverages in accordance with some embodiments of the present invention.

The body of the faucet 1004 forms a housing for the capsule 1002; as seen in the figure, the capsule 1002 is inserted and fixedly held within the body of the faucet 1004.

As seen in the figure, a water stream enters the faucet 1004 at point 1006 and flows upwards. On its way upwards, the water stream passes by capsule 1002, dissolves the capsule 1002, and mixes with the capsule's content. The mixture continues flowing upwards and exiting through the faucet tip 1008.

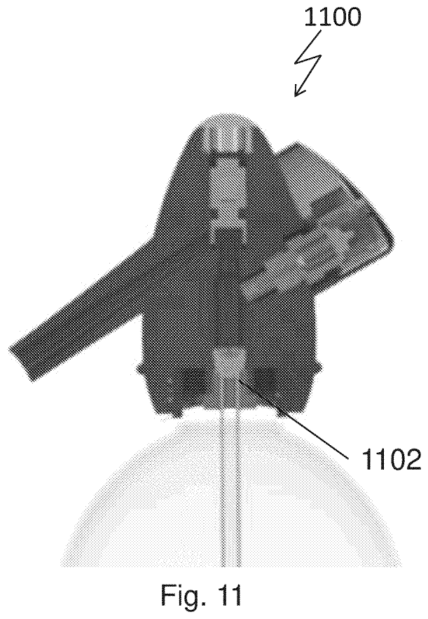

FIG. 11 illustrates a soda siphon carbonated water maker 1100 with a capsule secured in a funnel-type housing 1102 for producing beverages as described in FIGS. 2A-C, 3A-D, 7A-C, and 9A-D.

It should be noted that in each and every embodiment described above, it is possible that the planar upper wall and/or the planar bottom wall of the capsule may be soluble in water.

1. A set-up to be implemented in a water/beverage system for adding flavors, minerals, and/or nutritional supplements to beverages comprises:
a sealed capsule containing said flavors, minerals and/or nutritional supplements, said capsule comprises a container with an upper wall and a bottom wall that are either tearable and/or dissolvable when subjected to a stream of fluid and/or to a pressure/force exerted thereon, and
a housing for securely holding said capsule in said water/beverage system.

2. The set-up of claim 1, wherein said water/beverage system is selected from water purification and filtration systems and systems for making carbonated/non-carbonated beverages.

3. The set-up of claim 1, wherein said housing is a funnel-type housing.

4. The set-up of claim 1, wherein said container is a cup-shaped container.

5. The set-up of claim 4, wherein said cup-shaped container is a self supporting cup-shaped container with planar bottom and upper walls, and a side wall, part of said side wall gradually truncates towards said planar bottom wall.

6. The set-up of claim 5, wherein said side wall is made of a stiff material selected from a metal, a metal alloy, polymer(s), a polymer-metal/metal alloy composite material or a combination thereof.

7. The set-up of claim 5, wherein said planar bottom wall and/or said planar upper wall is made of soft/semi soft material selected from a soft metal/alloy, polymer(s) or a combination thereof.

8. The set-up of claim 1, wherein said capsule is either a soluble or a non soluble capsule.

9. The set-up of claim 7, wherein said soluble capsule is made of material(s) or chemical(s) that react with water, said material(s) or chemical(s) are selected from gelatin, starch, sugar, fibrous or cellular materials, sodium, calcium or a polymer.

10. The set-up of claim 9, wherein said polymer is a PVOH-Polyvinyl alcohol.

11. The set-up of claim 1, wherein said housing is a funnel-type housing.

12. The set-up of claim 11, wherein said funnel-type housing holds the capsule in place and conveys the content of the capsule into a water/sparkling water medium in said water/beverage systems.

13. The set-up of claim 1, wherein said set-up is implemented in a drinking water faucet to produce a carbonated/non-carbonated beverage, said housing is a body of said faucet into which said capsule is insertable, wherein water/carbonated water flows upwards/downwards within said body of said faucet towards a faucet tip, passes by and dissolves said capsule, and mixes with the capsule's content, a mixture of said water/carbonated water and said capsule's content continues flowing towards said faucet tip.

14. A method for using the setup of claim 1 in a water/beverage system for adding flavors, minerals, and/or nutritional supplements to beverages comprising:
positioning said set-up in said water/beverage system, said set-up comprises a capsule and a funnel-type housing; and
subjecting an upper wall of said capsule to a stream of fluid and/or to a pressure/force to tear/dissolve said upper wall and to tear/dissolve a bottom wall of said capsule.

15. The method of claim 14, wherein said water/beverage system is selected from water purification and filtration systems, sparkling water makers, and industrial and semi-industrial machines.

16. The method of claim 14, wherein said stream of fluid is a gaseous stream having a pressure of at least 40 Bar.

17. The method of claim 14, wherein said sparkling water maker is a soda siphon carbonated water and said method further comprising:
subjecting a gaseous stream to an upper wall of said capsule,
tearing said upper wall and a bottom wall of said capsule via said gaseous stream, flowing said gaseous stream through said funnel-type housing into a water medium, and
flowing sparkling water mixed with said capsule content upwards through said funnel-type housing and through said capsule.

18. The method of claim 14, wherein said sparkling water system is a Soda Stream jet sparkling water maker, and said method further comprising:
subjecting a gaseous stream to an upper wall of said capsule,
tearing said upper wall and a bottom wall of said capsule via said gaseous stream, and
flowing said gaseous stream through said funnel-type housing into a water medium.

19. The method of claim 14, further comprising:
subjecting a water stream to an upper wall of said capsule,
dissolving said upper wall and a bottom wall of said capsule via said water stream, and
flowing said water stream through said funnel-type housing into a water medium.

20. The method of claim 14, further comprising:
subjecting said upper wall of said capsule to force;
tearing said upper wall via said force,
directing a water stream into the capsule,
dissolving a bottom wall of said capsule via said water stream, and
flowing said capsule's content through said funnel-type housing into a water medium.

21. The method of claim 14, further comprising:
subjecting said upper wall of said capsule to force;
tearing said upper wall via said force,
directing a water stream into the capsule,
dissolving a bottom wall of said capsule via said water stream, and
flowing said capsule's content through said funnel-type housing into a water medium.

22. The method of claim 14, further comprising:
subjecting said upper wall of said capsule to force;
tearing said upper wall via said force,
directing a gaseous stream into the capsule,
tearing a bottom wall of said capsule via said gaseous stream, and
flowing said capsule's content through said funnel-type housing into a water medium.

23. The method of claim 14, further comprising:
subjecting said upper wall of said capsule to force;
tearing said upper wall via said force,
directing a water stream into the capsule,
tearing a bottom wall of said capsule via said water stream, and flowing said capsule's content through said funnel-type housing into a water medium

24. The method of claim 14, further comprising:
subjecting said upper wall of said capsule to force;
tearing said upper wall via said force,
directing a gaseous stream into the capsule,
tearing and/or dissolving a bottom wall of said capsule via said gaseous stream,
flowing said capsule's content through said funnel-type housing into a water medium, and
flowing sparkling water mixed with said capsule content upwards through said funnel-type housing and through said capsule.

25. The method of claim 17, further comprising dissolving said capsule.
